(19) United States
(12) Patent Application Publication
(10) Pub. No.: US 2006/0141843 A1
(43) Pub. Date: Jun. 29, 2006

(54) Hooking mechanism of a connector

(75) Inventors: Hung Way Huang, Hsin Tien, Taipei (TW); Swu Lin Dwan, Hsin Tien, Taipei (TW); Fang Hwung Wang, Hsin Tien, Taipei (TW)

Correspondence Address: MICHAEL LIN, 5F 79 Roosevelt Rd. Sec. 2, TAIPEI, 106, TW

(73) Assignee: ADVANCED CONNECTEK INC., Hsin Tien, Taipei (TW)

(21) Appl. No.: 10/907,107

(22) Filed: Mar. 21, 2005

(30) Foreign Application Priority Data
Dec. 24, 2004 (TW) 093220895

(51) Int. Cl. H01R 13/627

(52) U.S. Cl. 439/350

(57) ABSTRACT

The present invention discloses a latching structure of a connector, to make the connector and the mating connector achieve a perfect latching effect by providing a resilient latching member in the connector. The resilient latching member is a one-piece construction comprising a base portion and a spring portion, the spring portion has a pressing portion, a plurality of extending portions and latching hooks, the base portion has clasping portions fixed inside the connector making the spring portion become a movable free end, the extending portions and the clasping hooks could be shifted jointly by use of the pushing portion of the plastic cover pressing the pressing portion, making the clasping hooks change positions.

### FIELD OF THE INVENTION

The present invention relates to a latching structure of a connector, particularly to a latching structure making the resilient latching member shift by means of pushing a pushing member.

### DESCRIPTION OF RELATED ART

With technical advancements, electronic related products are updated every day, various new technologies are applied in every field of the electronic related products, even the development of transmission interfaces would be surprising. In recent years, various transmission interfaces are presented to the public continuously, such as the universal serial bus (USB), the digital video interface (DVI) as well as the high definition multi-media (HDMI), and so on, the connector products adapted to these interfaces are also emerged constantly; in addition to the transmission speed and content varieties, the foregoing various connectors are strict in connecting stable effect in order to increase connecting stability against from disconnecting due to unwanted reasons when using. A connector with latching hooks on the connecting portion thereof has been disclosed, such as a Taiwan patent application number 93,205,458, which discloses an HDMI connector comprising an insulative housing A, pressing strips B, a plastic protective cover C, latching members D and a mating outer shell E etc, therein, the insulative housing A has through slots and fastening slots for retaining and fastening the latching members D, the latching members D are fastened by the pressing strips B, on the upper surface of the plastic protective cover C having a spring piece C1, on the two sides of the upper surface of the mating outer shell E each having a through hole E1, the spring piece C1 is pushed downward to abut against the protrusions D1 on the main bodies of the latching members D, then the latching members D are moved downward to make the barbs D2 sink into the through holes E1 so as to control plugging or unplugging operation of the connector.

Indeed the foregoing structure has the advantages to achieve stability when the connector is used, but because the latching members are designed in a two-piece structure and must be pushed downward at the same time to achieve their functions, therefore a relatively strong force is needed to push the spring piece abutting against the protrusions of the main bodies of the latching members simultaneously, because the contact surfaces of the two protrusions are too small to wear the spring piece away easily, a much stronger force is needed to achieve the predetermined functions after the spring piece is worn away. Moreover, the force must be applied on the center of the spring piece to push down the two latching members jointly, if the force slants left or right, it would such that one latching member is pushed down but the other could not be pushed down completely, which causes inconveniency in using.

### SUMMARY OF THE INVENTION

A main object of the present invention is to provide a latching structure of a connector which makes the resilient latching member shift by pressing a pushing member.

Another object of the present invention is to provide a latching structure of a connector having an integral resilient latching member, to avoid the latching hooks on two sides of the connecting portion of the connector from being pressed down on one side but not completely on the other side, to ensure the latching hooks could shift simultaneously.

Accordingly, in the present invention a connector with a latching structure comprises a terminal seat, a metal case, a plastic cover and a resilient latching member. The metal case encloses the terminal seat, the plastic cover encloses the terminal seat and the metal case, the base portion of the resilient latch member has a plurality of clasping portions, the front end of the base portion extends a spring portion, the spring portion has a pressing portion, the pressing portion has a plurality of extending portions, each end of the extending portion has a latching hook, the foregoing clasping portions are press-fitted within the terminal seat, the extending portions are positioned within the terminal seat.

The rear end of the terminal seat has a plurality of clasping slots and insertion slots, the clasping slots are adapted to press-fit the clasping portions of the latching member, the insertion slots are adapted to retain the extending portions of the resilient latching member; the front end of the terminal seat has a connecting portion, the connecting portion has a plurality of hook holes, the foregoing latching hooks project out from the hook holes respectively; the plastic cover is provided with a pushing member, the pushing member abuts against the pressing portion, when the pushing member is pushed, the spring portion shift positions elastically to make the extending portions shift jointly and cause the latching hooks sink into the hook holes due to the pressing portion is pressed.

In order for the structure and technique features of the present invention are more apparent to those skilled in the art, a detailed description of preferred embodiments is given hereafter with attached drawings.

### DETAILED DESCRIPTION OF THE PREFERRED EMBODIMENTS

Referring to FIGS. 1-3, which are exploded and assembled views of a preferred embodiment of the present invention. In the present invention, the connector with a latching structure comprises a terminal seat 1, a metal case 3, a plastic cover 4 and a resilient latching member 2, the metal case 3 enclosing the terminal seat 1, the plastic cover 4 enclosing the terminal seat 1 and the metal case 3, the resilient latching member 2 being fixed inside the terminal seat 1.

Referring to FIG. 4, in the present embodiment, the two sides of the base portion 21 of the resilient member 2 each is bent downwardly to provide a clasping portion 22, the front end of the base portion 21 extends to connect a spring portion 23, the spring portion 23 has a pressing portion 231 protruding upward, from the pressing portion 231 to the two sides thereof each having an extending portion 232 extended forward, the distal end of the extending portion 232 has a clasping hook 233; because the clasping hooks 233 and the extending portions 232 are connected to the free end of the spring portion 23, the clasping hook 233 and the extending portion 232 would shift positions jointly along with the pressing portion 231 when the pressing portion 231 of the spring portion 23 is under pressure.

Then referring to FIG. 5, the rear end of the terminal seat 1 has a plurality of clasping slots 12 and insertion slots 13, the plurality of clasping slots 12 are adapted to press-fit a plurality of clasping portions 22 of the resilient latching member 2, the plurality of insertion slots 13 are adapted to contain a plurality of extending portions 232 of the resilient latching member 2, the connecting portion 11 has a plurality of hook holes 111, the foregoing clasping hooks 233 project out from the corresponding hook holes 11 respectively.

Referring to FIG. 1 again, the metal case 3 further includes an upper case 31 and a lower case 32, the upper case 31 has an aperture 311, which is adapted for the pressing portion 231 of the resilient latching member 2 passing through, the plastic cover 4 is provided with a pushing member 43, the foregoing plastic cover 4 further includes a front cover 41 and a rear cover 42, the front cover 41 and the rear cover 42 are provided with a retaining chamber formed by the cuts 411, 421 thereof for accommodating the pushing member 43, the pushing member 43 is provided with a plurality of sliding pieces 431, in the present embodiment, the sliding pieces 431 are positioned on the left side and right side of the pushing member 43, the plastic cover 4 has a plurality of sliding rails 44 on the sidewalls of the retaining chamber formed by the cuts 411, 421 corresponding to the sliding pieces 431 to make the pushing member 43 could be pushed along the direction the sliding rails 44 are provided, in the present embodiment, the sliding rails 44 are provided horizontally, i.e. the pushing member 43 could be shifted back and forth horizontally inside the retaining chamber formed by the cuts 411, 421 of the plastic cover 4.

Further referring to FIGS.6 and 7, which are sectional, using views of the embodiment in the present invention. The pressing portion 231 abuts against the pushing member 43, when the pushing member 43 is pushed, the spring portion 23 shift positions downward elastically for the pressing portion 231 is pressed to make the extending portions 232 shift positions downward jointly and cause the latching hooks 233 sink into the hook holes 111.

In the present invention, the pushing member 43 also could be designed in the press-down mode, which also could achieve the objects of the present invention by pressing downward the pushing member 43 to change the horizontal positions of the pressing member 231.

When the connector and the mating connector are in connected state, the clasping hooks 233 are projected out from the hook holes 11 to make the connector and the mating connector to be in reliable connection; when plug or unplug the connector, the pushing member 43 is pushed to make the clasping hooks 233 sink into the hook holes 111 so as for the connector could be unplugged from or plugged into the mating connector conveniently.

The structures of the embodiments disclosed in the present invention are illustrative only and not limitative to the scope of the present invention, any changes or modifications made by those skilled the art via the description of the present invention without departing from spirits of the invention are considered as like structures of the invention and covered by the claims of the present invention.

### BRIEF DESCRIPTION OF THE DRAWINGS

FIG. 1 is an exploded perspective view of the preferred embodiment of the present invention.

FIG. 2 is a partially assembled view of the preferred embodiment of the present invention.

FIG. 3 is an assembled perspective view of the preferred embodiment of the present invention.

FIG. 4 is a perspective view of the resilient latching member in the preferred embodiment of the present invention.

FIG. 5 is a perspective view of the terminal seat in the preferred embodiment of the present invention.

FIG. 6 is a sectional, using view of the preferred embodiment of the present invention.

FIG. 7 is another sectional, using view of the preferred embodiment of the present invention.

FIG. 8 is an exploded perspective view of an existing connector with a latching structure.

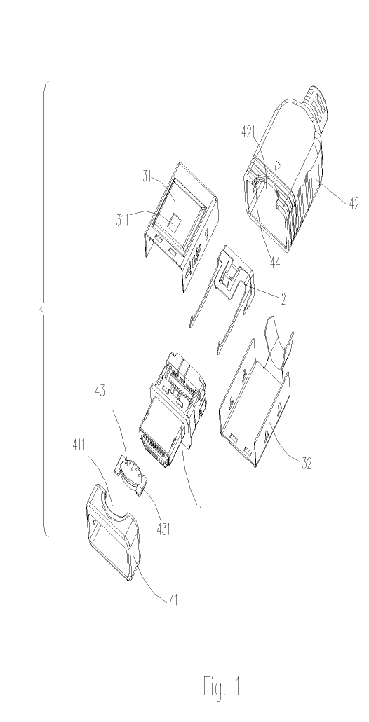

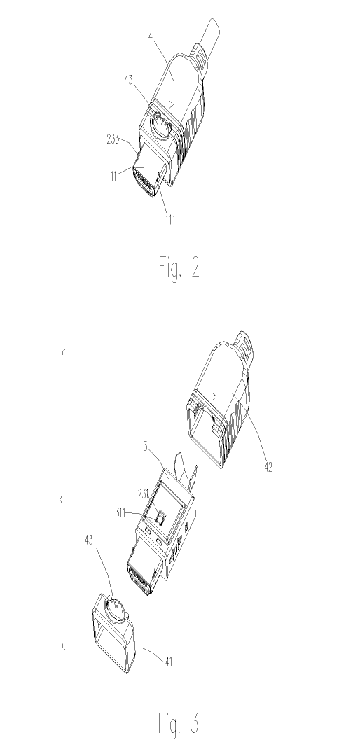

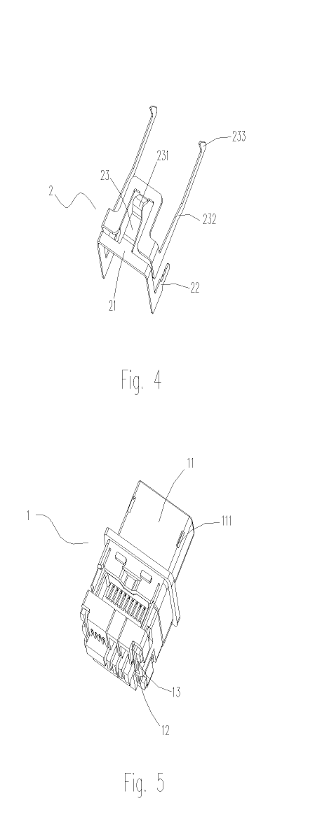

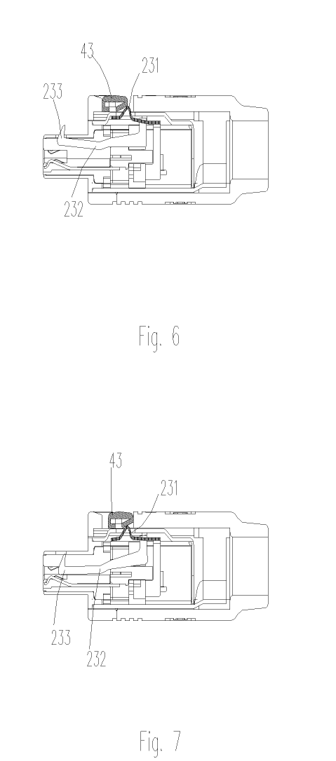

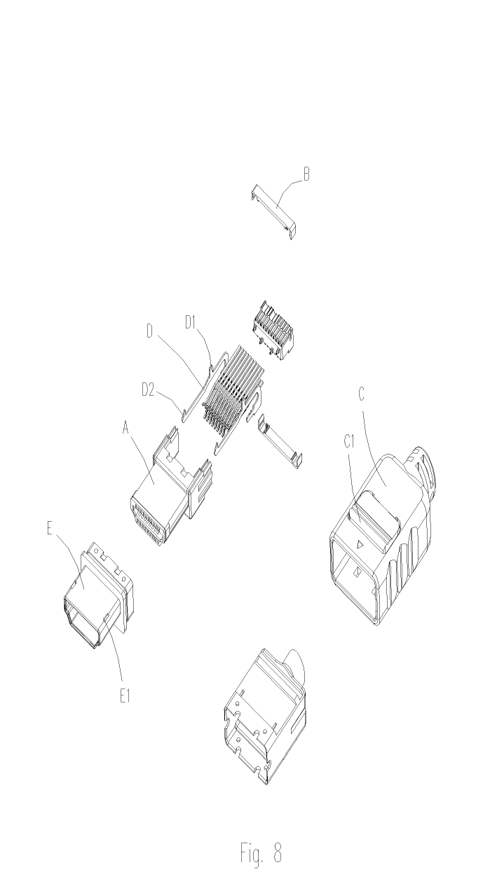

What is claimed is:

1-6. (canceled)

7. A connector with a latching structure comprising:
a terminal seat;
a metal case enclosing said terminal seat;
a plastic cover enclosing said terminal seat and said metal case; and
a resilient latching member fixed inside said terminal seat; wherein:
said resilient latching member is used in the connector for buckling a mating connector comprising:
a base portion having a plurality of clasping portions; and a spring portion; wherein a front end of said base portion extends to connect said spring portion, said spring portion has a pressing portion, said pressing portion is connected to and provided with a plurality of extending portions, each extending portion has a clasping hook, said clasping portions are fixed inside said connector to make said spring portion become a movable free end, said extending portions and said clasping hooks could be shifted jointly by pressing said pressing portion, making said clasping hooks change positions.

8. The connector with a latching structure as claimed in claim 1, wherein the metal case further includes an upper case and a lower case, the upper case has an aperture, which is adapted for the pressing portion of the resilient latching member passing through, the plastic cover is provided with a pushing member, the plastic cover further includes a front cover and a rear cover, the front cover and the rear cover are provided with a retaining chamber formed by a plurality of cuts thereof for accommodating the pushing member, the pushing member is provided with a plurality of sliding pieces positioned on the left side and right side of the pushing member, the plastic cover has a plurality of sliding rails on sidewalls of the retaining chamber formed by the cuts corresponding to the sliding pieces to make the pushing member to be pushed along the direction the sliding rails are provided, wherein the sliding rails are provided horizontally, i.e. the pushing member could be shifted back and forth horizontally inside the retaining chamber formed by the cuts of the plastic cover.

9. The connector with a latching structure as claimed in claim 1, wherein the pressing portion abuts against the pushing member, when the pushing member is pushed in horizontal direction, the spring portion shift positions downward elastically for the pressing portion is pressed to make the extending portions shift positions downward jointly and cause the latching hooks sink into the hook holes.
